(19) United States
(12) Patent Application Publication
(10) Pub. No.: US 2023/0196305 A1
(43) Pub. Date: Jun. 22, 2023

(54) DEVICES TO SERVICE PHYSICAL CONDITIONS OF ROOMS

(71) Applicant: HEWLETT-PACKARD DEVELOPMENT COMPANY, L.P., Spring, TX (US)

(72) Inventors: Endrigo NADIN PINHEIRO, Spring, TX (US); Nicholas SUTTON, Spring, TX (US)

(21) Appl. No.: 17/556,994

(22) Filed: Dec. 20, 2021

(51) Int. Cl. G06Q 10/00

(52) U.S. Cl. CPC G06Q 10/20

(57) ABSTRACT

An example device includes a user interface positionable at a room, a network interface to communicate with a computer network, a processor connected to the user interface and the network interface. The processor outputs at the user interface a user-interface element associated with a physical condition of the room, receives a selection of the user-interface element from an occupant of the room, and, in response to the selection of the user-interface element, transmits to a server via the network interface a service request related to the physical condition of the room.

### BACKGROUND

Physical spaces, such as meeting rooms, are used by people to communicate and share information. A room will often have a technological component, such as a computer or teleconference device to facilitate display of information and remote communications. Such a room will also often have low-tech resources, such as whiteboards, markers, and climate control.

### BRIEF DESCRIPTION OF THE FIGURES

FIG. 1 is a diagram of an example device to receive input related to a physical condition of a room and to transmit a service request related to the physical condition.

FIG. 2 is a diagram of an example mapping of plural physical conditions, user-interface elements, and service requests.

FIG. 3 is a diagram of an example user interface to select various physical conditions of a room to transmit respective service requests.

FIG. 4 is a diagram of the example user interface of FIG. 3 showing changing priorities among physical conditions and respective user-interface elements.

FIG. 5 is a diagram of an example data structure to generate service request commands to target entities responsible for remedying physical conditions of a room.

FIG. 6 is a diagram of example data structure similar to that of FIG. 5 to capture room service history.

FIG. 7 is a diagram of example room assistant, server, and target entity computing devices to generate service request commands to target entities.

FIG. 8 is a diagram of an example device and server arrangement to generate service request commands to target entities and provide booking information related to physical conditions of rooms.

### DETAILED DESCRIPTION

Resources of physical spaces often fail or become depleted. Technology resources, such as computers, computer cables, and audio-visual devices, may stop working properly for any number of reasons, such as hardware failure, software failure, or outdated configuration. Components such as cables, mice, and keyboards are easily misplaced. Batteries may drain down. Non-technological resources, such as whiteboard markers, chairs, tissue paper, and water, may be get used up. Temperature control may fail or may not be accessible from the room. A space may simply need cleaning.

The occupants of a meeting room may be unaware as to who is responsible to remedy these deficiencies, particularly in a large organization or large building where multiple different parties manage various resources. Often, room users resign themselves to just cope with the lack of resources.

A user-interface device may be provided to a physical space to provide quick and efficient indication of a failure, malfunction, or depleted resource of the physical space. A user interface may directly correlate user-interface elements (e.g., touchscreen buttons or voice commands) to physical conditions to be remedied. The device may automatically create a service request for the condition for direct communication to an office administrator, an information technology (IT) ticketing system, a building superintendent, or other specific target party responsible for correcting a particular condition. As such, a room user may easily and conveniently indicate the physical condition in need of correction to efficiently inform the respective party.

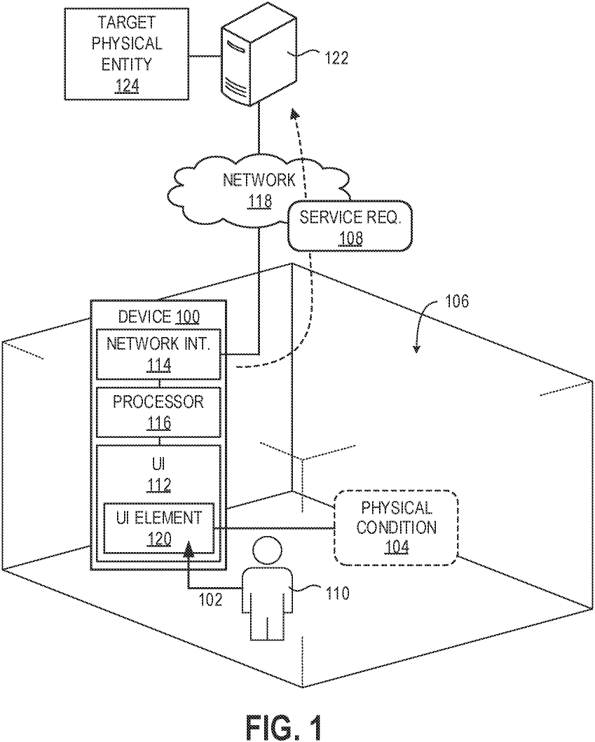

FIG. 1 shows an example device 100 to receive input 102 related to a physical state or condition 104 of a room 106 and to transmit a service request 108 related to the physical condition 104. The device 100 may be a computing device, such as teleconferencing computer installed at the room 106, a scheduling device installed at a doorway of the room, or a similar device. The device 100 may be attached to a fixture, piece of furniture, or wall at the room 106 and may be non-removeable from the room 106. The room 106 may be a meeting room, boardroom, office, auditorium, lecture hall, classroom, lab, or other room where people may gather to communicate. A device 100 may be provided to any number of different rooms 106 of a building.

The device 100 may provide teleconference functionality, such as starting/ending video/audio calls, controlling an in-room camera, dialing a telephone number, answering a call, operating as a speakerphone, and similar. The device 100 may cooperate with a camera and large-format display device or projector at the room 106. The device 100 may provide scheduling functionality, such as displaying meetings scheduled at the room and creating, modifying, and canceling such meetings.

The device 100 may be used by visitor to the room 106 or other person in or near the room 106, generally termed an occupant 110, to provide input 102 regarding observation of the physical condition 104 of the room 106. The device 100 may use such input 102 to trigger a service request 108 for the party responsible for the physical condition 104 of the room 106 to remedy a problem with the room 106 identified by the occupant 110. Example physical conditions relate to physical resources, such as whiteboard markers and chairs, and physical states, such as excessively hot or cold room temperatures and state of cleanliness. The device 100 may allow a room occupant 110 to quickly and efficiently issue a request for more markers, more chairs, or a change in room temperature.

The device 100 includes a user interface 112, a network interface 114, and a processor 116 connected to the user interface 112 and network interface 114. The user interface 112, network interface 114, and processor 116 may be provided in a single housing. Alternatively, the user interface 112 may be provided in a separate housing to the processor 116 and may connected to the processor 116 by a cable or wirelessly.

The user interface 112 is positionable at a room 106. For example, the user interface 112 may be positioned on a table in the room, secured to a wall inside the room, or secured to a wall outside the room near the door, for example. The user interface 112 may include a physical user-interface element, such as a touchscreen, microphone, speaker, keyboard, touchpad, camera, proximity sensor, button, or similar hardware input/output device. The user interface 112 may also include a software or programmatic user-interface element, such as a touchscreen button, image, video, sound, and so on.

The network interface 114 communicates with a computer network 118, such as a local-area network (LAN), wide-area network (WAN), or the internet. The network interface 114 may include a network adapter and related driver to communicate data with other computing devices via the network 118.

The processor 116 may include a microcontroller, a central processing unit (CPU), a field-programmable gate array (FPGA), an application-specific integrated circuit (ASIC), or a similar device capable of executing instructions.

The instructions may be directly executed, such as binary or machine code, and/or may include interpretable code, bytecode, source code, or similar instructions that may undergo additional processing to be executed. All of such examples may be considered executable instructions.

The processor 116 may cooperate with a non-transitory machine-readable medium that may include a non-volatile memory, such as read-only memory (ROM), electrically-erasable programmable read-only memory (EEPROM), or flash memory. The non-transitory machine-readable medium may include an electronic, magnetic, optical, or other physical storage device that encodes the instructions that implement the functionality discussed herein. The processor 116 may also cooperate with a non-transitory machine-readable medium that includes a volatile memory, such as a random-access memory (RAM).

The processor 116 outputs at the user interface 112a user-interface element 120 directly associated with the physical condition 104 of the room 106. The user-interface element 120 may include a touchscreen button with an icon, text, or both an icon and text that are representative of the physical condition 104 of the room 106. For example, if the physical condition is the absence or condition (e.g., out of ink) of whiteboard markers in the room 106, then a touchscreen button may have an icon of a marker with the text “Need Markers.”

The processor 116 receives a selection of the user-interface element 120 from an occupant 110 of the room 106 and, in response, transmits to a server 122 via the network interface 114 a service request 108 related to the physical condition 104 of the room 106. The server 122 may be accessible to a physical entity 124 assigned to remedy the physical condition of the room. For example, the server 122 may communicate the service request 108 to an office administrator/manager who can deliver more markers to the room or order more markers if none are readily available. In another example, the physical entity 124 is an IT ticket system that accepts and tracks problems with computer and A/V equipment in the room 106.

Hence, an occupant 110 of the room 106 who observes a deficient physical condition 104 may provide an input 102 to a preconfigured user interface 112 to quickly and efficiently dispatch a target entity 124 to correct the deficient physical condition 104.

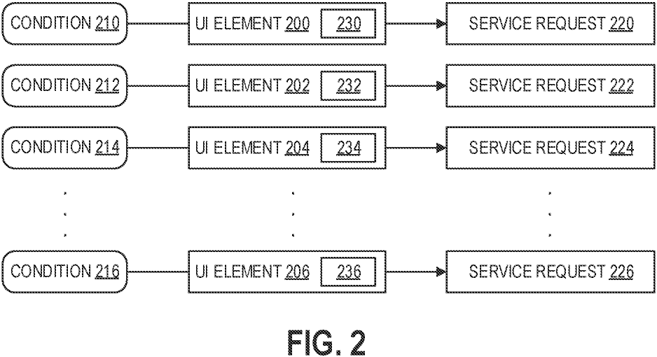

FIG. 2 shows an example mapping of plural physical conditions, user-interface elements, and service requests.

Any suitable number of first, second, and so on user-interface elements 200, 202, 204, 206 may be associated with various different respective physical conditions 210, 212, 214, 216 of a physical space. The association may be a one-to-one association, so that selection of a user-interface element 200, 202, 204, 206 unambiguously indicates a different respective physical condition 210, 212, 214, 216.

Examples of user-interface elements 200, 202, 204, 206 include touchscreen buttons, depressible buttons, and a microphone coupled to a virtual assistant to process voice commands. A button may display a description of the associated physical condition with text, icon, etc. A virtual assistant may have a keyword assigned to each physical condition. For example, a virtual assistant may be configured to monitor for the spoken words “marker,” “markers,” and “ink” for a physical condition that relates to missing or dry whiteboard markers. The virtual assistant may be configured to detect such keyword after detecting a wake word (e.g., “Hello, Room Assistant?”). The virtual assistant may also be configured to verbally confirm an apparent voice command (e.g., “Shall I obtain more whiteboard markers for this room?”) and respond to confirmation/denial accordingly. A virtual assistant’s keywords and confirmation process may be considered user-interface elements.

The user-interface elements 200, 202, 204, 206 may further be associated with respective service requests 220, 222, 224, 226 that are targeted to respective physical entities assigned to remedy the respective physical condition 210, 212, 214, 216. This association of user-interface elements to service requests may also be one-to-one, so that selection of a user-interface element 200, 202, 204, 206 generates a respective service request 220, 222, 224, 226 to unambiguously notify the responsible physical entity.

The user-interface elements 200, 202, 204, 206 may further be associated with respective indicators 230, 232, 234, 236. An indicator 230, 232, 234, 236 may indicate a time since selection of the respective user-interface element 200, 202, 204, 206 or transmission of the respective service request 220, 222, 224, 226. Time may be indicated by a text string (e.g., 11:28 AM), a visual characteristic, or an audio characteristic. Visual characteristics may include color, highlighting, or iconography of a user-interface elements 200, 202, 204, 206. For example, a touchscreen button may gradually change color as time since reporting the condition increases. Audio characteristics include computerized speech, chimes, or similar.

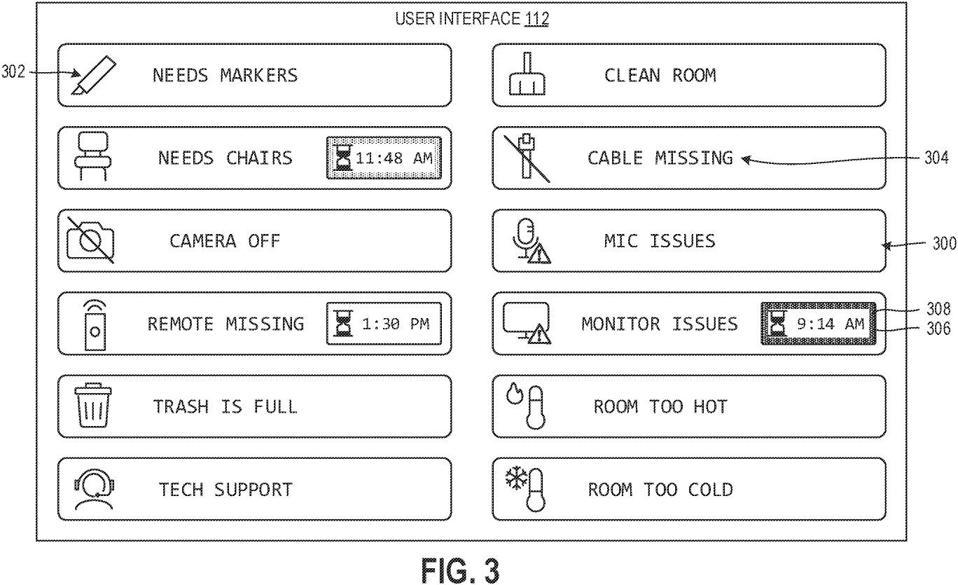

FIG. 3 shows an example user interface 112 to select various physical conditions of a room or other physical space to transmit respective service requests. In this example, the user-interface includes an arrangement of touchscreen buttons 300 assigned to different physical resources or physical states of the room.

A button 300 may include an icon 302 and a text descriptor 304 that unambiguously describe the respective physical condition. In various examples, unambiguous indication of the physical condition to be corrected reduces or prevents unintended requests and makes the corrective process more efficient. For example, buttons 300 that indicate a missing computer cable and a problem with a room microphone being separate provides greater information to the respective target parties responsible for correcting the problem. With the former, a responding IT worker may bring a set of commonly missing cables. With the latter, the responding IT worker may bring a replacement microphone.

Specific and unambiguous buttons 300 reduce or minimize the number of possible choices for a given problem, while at the same time provide clear direction as to the next step to be taken by the responding entity.

A button 300 may include a time indicator 306 to indicate a time of the service request. The indicated time may be the time at which the button was pressed by an occupant of the room, the time at which the service request was generated and communicated to the target party, or the time at which the target party acknowledged the service request.

As indicator, such as the time indicator 306, may appear when a service request is made and may disappear after the service request has been completed, so as to prevent subsequent unnecessary or redundant service requests. Further, displaying the time may provide a simple status of the service request to occupants of the room.

The time indicator 306 may display a visual characteristic that changes as time increases. For example, a color of the time indicator 306 (depicted as shading in the figure) may start yellow and gradually transition to red as time increases.

Example room conditions represented as respective button text and icons are shown in FIG. 3. A deficient physical condition may include the absence of a resource or the condition of the resource, for example, an absence of chairs or the condition of whiteboard markers being dry or empty. Examples of room physical conditions include an absence or a condition of a whiteboard marker, piece of furniture, computer cable, piece of teleconference equipment, piece of computer equipment; the room being insufficiently clean; and the room having an uncomfortable temperature, that is, being too hot or too cold.

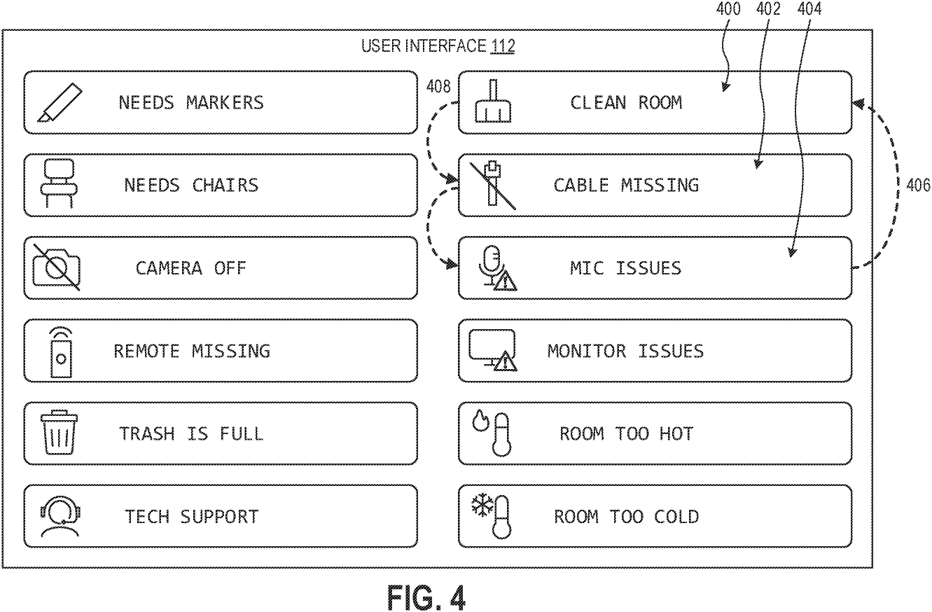

FIG. 4 shows the example user interface 112 of FIG. 3 with changing priorities among physical conditions and respective user-interface elements.

The user-interface elements, such as buttons 400, 402, 404, may be arranged based on a dynamic relative prioritization of the respective physical conditions. The prioritization is relative in that buttons 400, 402, 404 may be located at positions according to their usage, where a button’s usage directly relates to prevalence of the underlying physical condition. For example, buttons 400, 402, 404 used more frequently may be placed above buttons 400, 402, 404 used less frequently. The prioritization is dynamic in that buttons 400, 402, 404 may be rearranged as usage changes. For example, as shown, if a room’s microphone begins to malfunction more frequency, then the respective button 404 may be moved 406 to a higher location at the user interface, while buttons 400, 402 for problems of lesser frequency may be moved 408 downwards on the user interface. The above/below relationship of buttons 400, 402, 404 is merely an example and various user interfaces may provide for different spatial arrangements based on priority, such as central locations for higher-priority buttons and peripheral locations for lower-priority buttons.

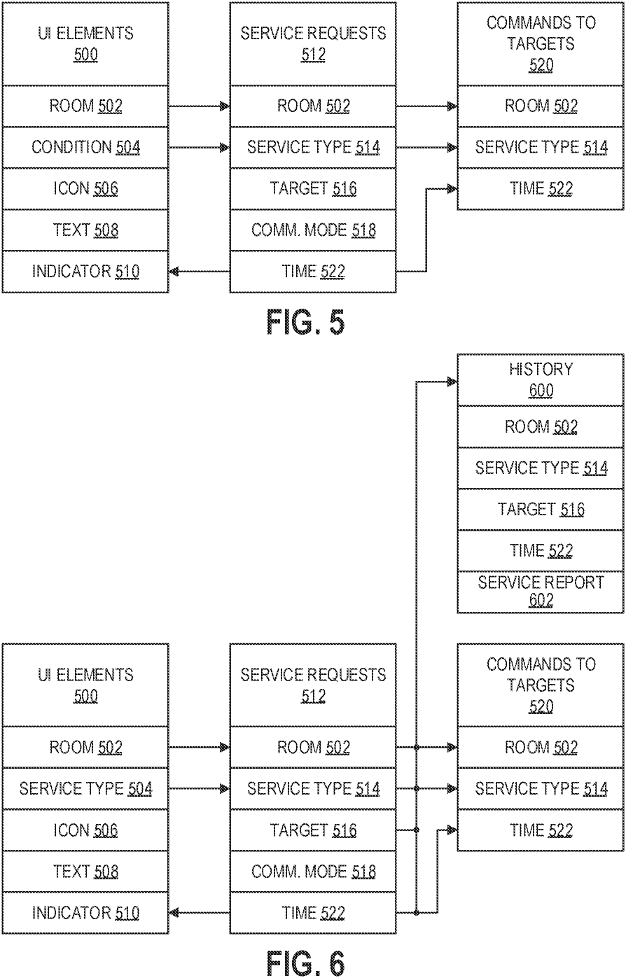

FIG. 5 shows an example data structure to generate service request commands to target entities responsible for remedying physical conditions of a room.

User-interface elements 500, such as buttons or virtual assistant commands, may be specific to room 502 and condition 504. That is, each user-interface element 500 may be associated with a room 502 and a specific condition 504 for that room 502. It is contemplated that different rooms 502 will be susceptible to different sets of conditions 504, as rooms 502 often have different resources. A set of user-interface elements 500 for the same room 502 define the set of possible conditions 504 for that room 502. In the case of touchscreen buttons, a user-interface element 500 may have an associated icon 506, text 508, and indicator 510.

Service requests 512 may be generated from input/selection of the user-interface elements 500. A service request 512 specifies the affected room 502 and service type 514 to correct the condition 504 observed at the room 502. The service request 512 also specifies the target entity 516 and communications mode 518. This allows for a mapping of service type 514 and room 502 to various different target entities 516 and respective communications modes 518. Target entities 516 may take responsibility for different rooms 502 and/or service types 514. For example, an administrative employee tasked with supplying stationery to meeting rooms may be identified as a target 516 for service types 514 related to stationery and may prefer instant messaging communications as a communications mode 518. Hence, whenever a service request 512 is generated for deficient stationery in a room 502, a respective command 520 is generated and transmitted to the target 516 via the specified communications mode 518.

Commands 520 to target entities 516 indicate the room 502 and service type 514 to the target entity so that the person or organization may respond to the service request 512 accordingly.

Service requests 512 may also indicate a time 522 of request, which may be fed back to the respective user-interface element 500 so that the indicator 510 may be updated with an expression of the time 522 or related visual characteristic. The time 522 of a service request may also be communicated with the command 520 to the target entity 516.

FIG. 6 shows an example data structure similar to that of FIG. 5 to capture to capture room service history 600.

Data from service requests 514 may be stored in the history 600. For example, indications of room 502, service type 514, target 516, and time 522 may be stored for future reference. History 600 may also store a service report 602 made by the target entity who carried out the service. The service report 602 may be structured or unstructured and may indicate whether the service was carried out successfully, the resources consumed, and details about the service, such as specific make and model of computing device or teleconferencing equipment serviced.

The history 600 may be queried to infer problem rooms, usage of service resources, workload of target entities who provide service, problem equipment, and so on. Further, past service requests stored in the history 600 may be used to disable booking of a room or recommend a room for new bookings. For example, queries may be issued to the history 600 on behalf of a calendaring program (e.g., Microsoft Outlook™, Google Calendar™, etc.) to determine whether a room should be recommended or not recommended for new meeting bookings. This determination may be made on various factors such as rooms with recent service, high frequency of service, low frequency of service, a specific type of service, etc.

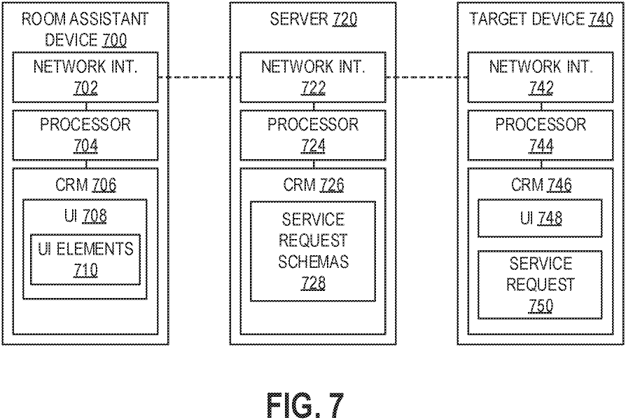

FIG. 7 shows example room assistant, server, and target entity computing devices to generate service request commands to target entities.

A room assistant computing device 700 includes a network interface 702, a processor 704, and a non-transitory machine-readable medium 706. Examples of network interfaces, processors, and media are discussed above and not repeated here. The room assistant computing device 700 may be a device specialized to implement the techniques discussed herein or may be a piece of teleconferencing equipment that also provides a teleconference interface associated with a teleconference system of the room, for example to schedule and run teleconferences.

The room assistant computing device 700 is positionable at or near a specific room to serve. The medium 706 stores a user interface 708 and user-interface elements 710, to indicate various physical conditions and request corresponding remedies, as discussed elsewhere herein.

The server 720 includes a network interface 722, a processor 724, and a non-transitory machine-readable medium 726. Examples of network interfaces, processors, and media are discussed above and not repeated here.

The server 720 is responsive to input at the room assistant device 700 via a network connection. The medium 726 stores service request schemas 728 that define service requests for various conditions reported by the room assistant device 700.

A service request schema, 728 may include content, such a descriptor for the service request (e.g., “Missing Cable”) and a mode of communication, such as application programming interface (API) request, an HTTP method (e.g., GET or POST), a representational state transfer (REST) request, or similar, as well as a target for the mode of communication, such as network address.

The server 720 may receive an assignment of a service request schema 728 to a particular target entity. A user interface may be implemented to associate service schemas 728 with service requests and targets.

The target entity computing device 740 includes a network interface 742, a processor 744, and a non-transitory machine-readable medium 746. Examples of network interfaces, processors, and media are discussed above and not repeated here. The target entity computing device 740 may be a ticketing computing device that manages service tickets for a group of users, a portable device carried by a service user, or similar.

The medium 746 may store a user interface 748 to manage service requests 750 received from the server 720. Service requests 750 may be displayed, accepted, rejected, marked as in process, marked as complete, or otherwise modified via the user interface 748.

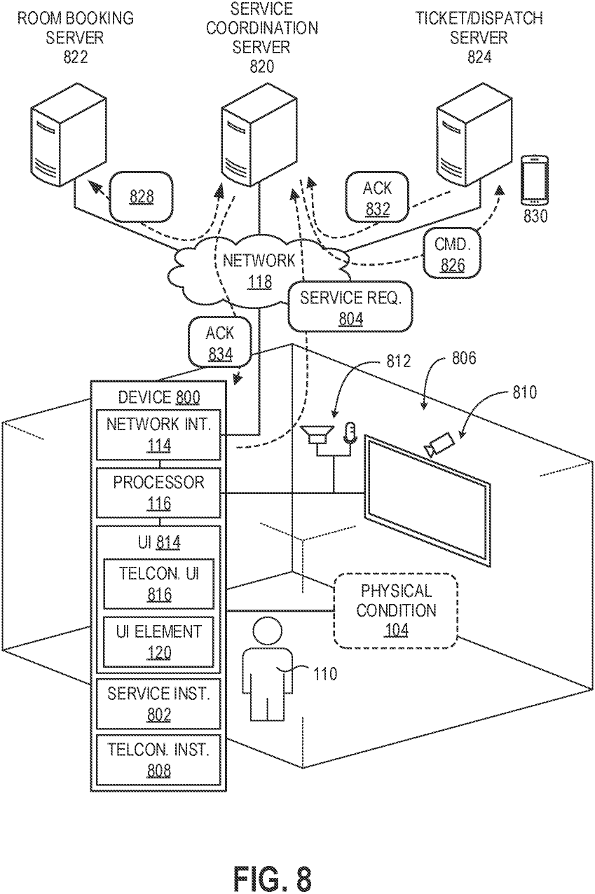

FIG. 8 shows an example device 800 and server arrangement to generate service request commands to target entities and provide booking information related to physical conditions of rooms. The device 800 is similar to the devices 100, 700 discussed above and details of like components and functions will not be repeated here

The device 800 includes service instructions 802 to initiate and manage service requests 804 based on physical conditions of a room 806 and teleconference instructions 808 to carry out a teleconference in the room 806.

The room 806 may include a teleconference system, which may include user-interface elements or devices, such as a display device with camera 810 and a microphone and speaker 812, to facilitate a teleconference. The teleconference system may be connected to the device 800, which may initiate and control a teleconference

The device 800 includes a user interface 814, such as a touchscreen or virtual assistant. The user interface 814 includes a teleconference interface 816 associated with the teleconference system to schedule, start, and terminate teleconferences.

The user interface 814 includes a user-interface element 120 directly associated with a physical condition 104 of the room 806. Any number of user-interface elements 120 may be provided for any number of discrete physical conditions 104. A user-interface element 120 may include a touchscreen button, voice commands and response, or similar.

Example servers include a service coordination server 820, room-booking server 822, and a ticket/dispatch server 824. The device 800 may communicate with the servers 820, 822, 824 and the severs 820, 822, 824 may communicate with each other via a computer network 118.

The service coordination server 820 is similar to the server 720 of FIG. 7. The service coordination server 820 maintains associations of room conditions 104 to target entities able to correction such conditions, such as users or operators of the ticket/dispatch server 824. The service coordination server 820 responds to service requests 804 by selecting a target entity based on the condition 104 indicated in the service request 804, and communicates the service request 804 to the ticket/dispatch server 824 as commands 826 to remedy the condition 104.

The service coordination server 820 may respect to requests from the room booking server 822 by recommending the room 806, not recommending the room 806, or disabling booking of the room 806 based on past service requests 804. For example, a large number of service requests 804 or lack of expected response to service requests 804 by the ticket/dispatch server 824 may cause the service coordination server 820 to not recommend or disable booking of the room 806 to the room booking server 822. Conversely, few service requests 804 or expected responses to service requests 804 by the ticket/dispatch server 824 may cause the service coordination server 820 to recommend booking of the room 806 to the room booking server 822. Such Communications between the service coordination server 820 and the room booking server 822 are generally shown at 828.

The room booking server 822 may be a calendaring server, such as a Microsoft Outlook™ server that allows users to book meeting and select resources such as rooms for such meetings.

The ticket/dispatch server 824 may be an IT ticketing server, a short message service (SMS) server, an instant messaging server, or similar server capable of communicating with target entities, such as IT staff, cleaning staff, or the like, capable of remedying conditions in the room 806. Ticket/dispatch server 824 may receive commands 826 for service requests from the service coordination server 820 generate tickets for such requests and track the relevant action taken to perform the service. Alternatively or additionally, ticket/dispatch server 824 may receive commands 826 for service requests and forward the relevant information to target entities without follow up.

The device 800 may provide for the capture of an image, sound, or both with input via the user interface 814 when generating a service request 804. Capture may be performed using the microphone or camera of the teleconference system. The device 800 may communicate the image, sound, or both to the service coordination server 820 with the service request 804 to provide additional information concerning the physical condition 104, such as a photo of a broken piece of equipment or an audio recording of the occupant 110 describing the problem.

In operation, the device 800 receives via the user interface 814 an input from an occupant 110 of the room 806. The input selects a user interface element 120, such as by touching a button or saying a word, corresponding to a physical condition of the room 806 that the occupant 110 wishes to be remedied. The device 800 generates a service request 804 and send the service request 804 to the service coordination server 820. The service coordination server 820 identifies a ticket/dispatch server 824 for the service request 804 and generates and sends a command 826 to the ticket/dispatch server 824, which alerts a target entity’s computing device 830 as to the requested service. The ticket/dispatch server 824 communicates an acknowledgement 832 to the command 826 to the service coordination server 820, which may monitor action taken to respond to the service request 804. The service coordination server 820 may communicate an acknowledgement 834 or update for the service request 804 to the device 800 so that the device may display or otherwise output a status of the service request 804 via the user interface 814.

In view of the above, it should be apparent that quick and efficient indication of a failure, malfunction, or depleted resource of a physical space may be readily indicated by a user interface positioned at the physical space. The user interface may associate user-interface elements (e.g., touchscreen buttons or voice commands) to physical conditions to be remedied. Service requests for various conditions may be associated with target entities capable of correcting the conditions, such as an office administrator, IT ticketing system, etc. A room occupant may easily and conveniently, potentially with one touch or one word, indicate the physical condition in need of correction to have it corrected.

It should be recognized that features and aspects of the various examples provided above can be combined into further examples that also fall within the scope of the present disclosure. In addition, the figures are not to scale and may have size and shape exaggerated for illustrative purposes.

1. A device comprising:
a user interface positionable at a room;
a network interface to communicate with a computer network; and
a processor connected to the user interface and the network interface, the processor to:
output at the user interface a user-interface element associated with a physical condition of the room;
receive a selection of the user-interface element from an occupant of the room; and
in response to the selection of the user-interface element, transmit to a server via the network interface a service request related to the physical condition of the room.

2. The device of claim 1, wherein:
the user-interface element is a first user-interface element associated with a first physical condition of the room;
the service request is a first service request related to the first physical condition; and
the processor is further to:
output at the user interface a second user-interface element associated with a second physical condition of the room;
receive a selection of the second user-interface element from the occupant of the room; and
in response to the selection of the second user-interface element, transmit to the server via the network interface a second service request related to the second physical condition of the room;
wherein the second physical condition is different from the first physical condition of the room.

3. The device of claim 2, wherein the processor is further to arrange the first user-interface element and the second user-interface element at the user interface according to a dynamic relative prioritization of the first physical condition and the second physical condition.

4. The device of claim 1, wherein the user-interface element is associated with a time indicator, wherein the time indicator is to indicate a time at which the selection of the user-interface element was received from the occupant of the room.

5. The device of claim 4, wherein the time indicator includes a visual characteristic that is to change as the time increases.

6. The device of claim 1, wherein the user interface comprises a touchscreen and the user-interface element includes a button with an icon, text, or both representative of the physical condition of the room.

7. The device of claim 1, wherein the user interface comprises a virtual assistant and the user-interface element includes a microphone.

8. The device of claim 1, wherein the physical condition of the room comprises:
an absence or a condition of a whiteboard marker;
an absence or a condition of a piece of furniture;
the room being insufficiently clean;
an absence or a condition of a computer cable;
an absence or a condition of a piece of teleconference equipment;
an absence or a condition of a piece of computer equipment; or
an uncomfortable temperature.

9. A non-transitory machine- readable medium comprising instructions that, when executed by a processor, cause the processor to:
generate a user interface at a physical space;
receive via the user interface an input from an occupant of the physical space;
process the input to generate a command to remedy a physical resource or physical state of the physical space; and
communicate the command via a network to a server accessible to a physical entity assigned to remedy the physical resource or physical state of the physical space.

10. The non-transitory machine-readable medium of claim 9, wherein the user interface comprises an arrangement of touchscreen buttons assigned to different physical resources or physical states of the physical space.

11. The non-transitory machine-readable medium of claim 9, wherein the user interface comprises voice commands assigned to different physical resources or physical states of the physical space.

12. The non-transitory machine-readable medium of claim 9, wherein the user interface comprises a teleconference interface associated with a teleconference system of the physical space.

13. The non-transitory machine-readable medium of claim 9, wherein the instructions are further to:
receive a response to the command; and
update the user interface based on the response to display a status of the remedy to the physical resource or physical state of the physical space.

14. The non-transitory machine-readable medium of claim 9, wherein the instructions are further to capture image, sound, or both with the input and communicate the image, sound, or both to the server.

15. A server comprising:
a network interface to communicate with a computer network; and
a processor connected to the network interface, the processor to:
maintain an association of room conditions to target entities;
receive a service request from a user-interface device deployed to a room, wherein the service request specifies a condition of the room;
select a target entity based on the condition indicated in the service request and the association of room conditions to target entities; and
communicate the service request to a computing device operated by the target entity.

16. The server of claim 15, wherein the processor is further to:
receive an acknowledgement or update of the service request from the computing device operated by the target entity; and
communicate the acknowledgement or update to the user-interface device deployed to the room.

17. The server of claim 15:
further comprising storage to maintain service request schemas with different modes of communication;
wherein the processor is further to receive an assignment of a service request schema of the service request schemas to the target entity; and
wherein the processor is further to communicate the service request to the computing device operated by the target entity using the service request schema and a respective mode of communication.

18. The server of claim 15, wherein the processor is further to disable booking of the room based on past service requests.

19. The server of claim 15, wherein the processor is further to recommend the room for a new booking based on past service requests.

20. The server of claim 15, wherein the room conditions relate to physical resources and physical states of different rooms at a building.
